(19) United States
(12) Patent Application Publication
(10) Pub. No.: US 2020/0238279 A1
(43) Pub. Date: Jul. 30, 2020

(54) DEVICES, SYSTEMS, AND METHODS FOR SPECIMEN PREPARATION AND ANALYSIS USING CAPILLARY AND CENTRIFUGAL FORCES

(71) Applicant: Northwestern University, Evanston, IL (US)

(72) Inventors: David M. Kelso, Evanston, IL (US); Robert Elghanian, Evanston, IL (US)

(21) Appl. No.: 16/491,846

(22) PCT Filed: Mar. 8, 2018
(86) PCT No.: PCT/US2018/021567

§ 371 Date: Sep. 6, 2019

Related U.S. Application Data
(60) Provisional application No. 62/468,698, filed on Mar. 8, 2017.

(51) Int. Cl. B01L 3/00

(52) U.S. Cl. CPC B01L 3/50273; B01L 3/502738; B01L 2300/087; B01L 2400/0688; B01L 2300/0867; B01L 2300/0806; B01L 2400/0409; B01L 2400/0406; B01L 2300/0864; B01L 2200/0605

(57) ABSTRACT

Provided herein are devices, systems, and methods for specimen preparation by employing a combination of capillary and centrifugal forces, along with the addition of reagents at specified steps, followed by on-device sample analysis. For example, provided herein are devices, and methods of use thereof, that collect a sample by capillary force, separate components of the collected sample by centrifugal force, isolate one or more of the separated components by a second application of capillary force, mix the separated components with a first reagent from a storage compartment under centrifugal force, and continue to advance the materials through the device by alternating capillary and centrifugal forces, optionally with the addition of additional reagents from additional storage compartments, until final materials reach a test zone of the device for analysis.

### CROSS-REFERENCE TO RELATED APPLICATIONS

The present invention claims priority to U.S. Provisional Patent Application 62/468,698, filed Mar. 8, 2017, which is incorporated by reference in its entirety.

### FIELD

Provided herein are devices, systems, and methods for specimen preparation by employing a combination of capillary and centrifugal forces, along with the addition of reagents at specified steps, followed by on-device sample analysis. For example, provided herein are devices, and methods of use thereof, that collect a sample by capillary force, separate components of the collected sample by centrifugal force, isolate one or more of the separated components by a second application of capillary force, mix the separated components with a first reagent from a storage compartment under centrifugal force, and continue to advance the materials through the device by alternating capillary and centrifugal forces, optionally with the addition of additional reagents from additional storage compartments, until final materials reach a test zone of the device for analysis.

### BACKGROUND

Pre-analytic sample collection and preparation represent important steps in the analysis of biological and environmental samples. Most analytical technologies that detect substances or molecules of interest rely on at least one, if not multiple, sample preparation steps before the analysis can occur. Samples such as blood often must be collected from finger or heal sticks, or be sampled from collection containers such as a VACUTAINER device. For example, the detection of RNA, DNA, or proteins, whether native to a sample or from a foreign source (e.g., infectious disease agent, etc.) from biological samples such as blood, urine, saliva, cerebrospinal fluid, or the like often require that the target molecule of interest be separated from other components of the sample (e.g., cells, nucleases, proteases, inhibitors that are incompatible with the analysis assay, components that create background noise in the analytical technique, etc.). A wide variety of technologies have been developed to facilitate such sample collection and preparation. A common feature of many of these technologies is the need for complex and/or expensive equipment or reagents. While such technologies are acceptable in some applications and settings, they are unduly burdensome in others. For example, the cost and complexity of existing technologies makes them unaffordable, unavailable, or unusable in situations where funds are not available or where highly skilled technicians are not present. What are needed are low cost, easy to use alternatives.

### SUMMARY

Provided herein are devices, systems, and methods for specimen preparation by employing a combination of capillary and centrifugal forces, along with the addition of reagents at specified steps, followed by on-device sample analysis. For example, provided herein are devices, and methods of use thereof, that collect a sample by capillary force, separate components of the collected sample by centrifugal force, isolate one or more of the separated components by a second application of capillary force, mix the separated components with a first reagent from a storage compartment under centrifugal force, and continue to advance the materials through the device by alternating capillary and centrifugal forces, optionally with the addition of additional reagents from additional storage compartments, until final materials reach a test zone of the device for analysis. The devices, systems, and method allow one to: 1) obtain a precise volume of a sample or sample component (e.g., plasma) regardless of the volume of sample (e.g., blood) collected or its properties (e.g., hematocrit); 2) utilize existing centrifuge devices to generate the centrifugal forces (e.g., fit the discharge end of the device into a small diameter test tube); 3) assure sufficient volume of sample collected (e.g., finger and heel stick collection devices are difficult to use); 4) eliminate the need to pipet aliquot sample (e.g., plasma) (many medical workers are not skilled at pipetting); 5) mix specific volumes of the sample, or components separated therefrom, with specific volumes of reagents; and 6) add multiple different reagents at separate and discrete steps.

In some embodiments, devices are provided for sample preparation and analysis in multiple phases: (1) sample collection; (2) component separation (e.g., separating a desired component (e.g., plasma) from other unwanted portions of the sample (e.g., other blood components); (3) metering of desired components; (4) one or more steps of reagent addition and mixing; and (5) analysis. In some embodiments, an exemplary device (e.g., device 100 of FIG. 1) comprises: a sample collection zone 110 (e.g., comprising elements for collecting sample applied to the device); a component separation zone 120 (e.g., comprising elements for separating desired and undesired components of the sample); a metering zone 130 (e.g., comprising elements for metering of a specific of the collected sample components); a regent addition and mixing zone 140 (e.g., for the stepwise addition of reagents to sample components); and an analysis zone 150 (e.g., for performing an assay and/or deciphering the assay results). For example (see, e.g., FIG. 2), in some embodiments, provided herein is a device 200, comprising: (a) a sample collection zone comprising a porous membrane (e.g., a sample collection pad 210 of FIG. 2); (b) a separation zone comprising a separation chamber 220 in fluid communication with the sample collection zone via a separation channel 215 and positioned relative to the sample collection zone such that a centrifugal force applied along an axis of the device 200 moves a collected sample from the sample collection zone to the separation zone, and further comprising a waste chamber 225 in fluid communication with the separation chamber 220 such that a centrifugal force applied along an axis of the device moves denser undesired components of the sample into the waste chamber 225 while less dense desired components of the sample are retained in the separation chamber 220; (c) a metering zone comprising a metering reservoir 230 comprising a porous membrane (e.g., a metering pad 233), the metering reservoir 230 in passive fluid communication with the separation chamber 220 via a metering channel 236, but not in fluid communication with the sample collection zone or the waste chamber 225; (d) a reagent addition and mixing zone, comprising a first reagent storage reservoir 240 (e.g., a glass ampule), a first reagent gate 242, a first reagent addition channel 245, and a first mixing chamber 250, the first reagent mixing chamber 250 positioned relative to the metering zone and the first reagent storage reservoir 240 such that a centrifugal force applied along an axis of the device 200 moves the metered sample components from the metering zone, and reagents from the first reagent storage reservoir 240 (when the first reagent gate 242 is removed or broken (e.g., when the glass ampule is broken (e.g., by an actuator) or a seal removed)), to the first mixing chamber 250; the reagent addition and mixing zone further comprising a first siphon 262 (in passive fluid communication with the first mixing chamber 250 in the absence of centrifugation), a second reagent storage reservoir 270 (e.g., a glass ampule), a second reagent gate 272, a second reagent addition channel 275, and a second mixing chamber 260, the second reagent mixing chamber 260 positioned relative to the first siphon 262 and the second reagent storage reservoir 270 such that a centrifugal force applied along an axis of the device 200 moves the mixture of sample components and first reagent from the first siphon 262, and the second reagent from the second reagent storage reservoir 270 (when the second reagent gate 272 is removed or broken (e.g., when the glass ampule is broken (e.g., by an actuator) or a seal removed)), to the second mixing chamber 260; the reagent addition and mixing zone further comprising a second siphon 285 (in passive fluid communication with the second mixing chamber 260 in the absence of centrifugation) and an incubation chamber 280, the incubation chamber 280 positioned relative to the second siphon 285 such that a centrifugal force applied along an axis of the device 200 moves the mixture of sample components and reagents from the second siphon 285 to the incubation chamber 280; and (e) an analysis zone, comprising an assay chamber (e.g., test strip 290) and an absorbent pad 295, the analysis zone in passive fluid communication with the incubation chamber 280 such that the incubated mixture is drawn into the analysis zone in the absence of centrifugation.

In some embodiments, the arrangement and/or connectivity of elements within a device within the scope of embodiments herein differs from that which is set forth above and/or in FIG. 2. For example, the first mixing chamber may be connected to the second mixing chamber by one or more channels, chambers and/or absorbent materials, rather than a siphon. This and other such alterations to the arrangement and/or connectivity of elements within a device are envisioned herein and are within the scope provided. An aspect of the devices/systems herein is that the sample, component(s) thereof, reagents, and/or mixing/reaction products are advanced through the device (e.g., from sample collection zone to component separation zone to metering zone, through one or more reagent additions and mixings in the reagent addition and mixing zone, and into the analysis zone) by alternating pairs of passive flow (e.g., driven by capillary action of the channels and materials (e.g., absorbent pads) of the device) and centrifugal flow to create discrete steps within the device. In some embodiments, the devices/systems herein provide passive/centrifugal flow not just to prepare a sample for analysis, but also to add reagents to the sample and to perform on-device analysis.

In some embodiments, a device/system comprises a sample collection zone. The sample collection zone provides an interface between the exterior of the device and the channels/chambers/reservoirs/etc. within the device. In some embodiments, an opening is provided of sufficient size for a sample to be applied to the device. In typical embodiments, the sample is blood and the opening accommodates all or a portion of a pricked finger pad. In some embodiments, a sample collection pad resides under or within the opening. In some embodiments, the sample collection pad is of a suitably absorbent material to accept the desired volume of sample. The sample collection zone also comprises an outlet to allow flow (e.g., under centrifugal force) from the collection zone (e.g., sample collection pad) to the separation channel of the component separation zone. In some embodiments, the sample collection zone is an integral element of a device described herein. In some embodiments, the sample collection zone is a removable portion of a device described herein (as seen in FIGS. 1 and 2). A sample collection zone may also comprise additional elements (e.g., air vent, etc.) and functionalities, for example, those described in the devices of PCT/US16/50930 and U.S. Pro. App. No. 62/216,125; herein incorporated by reference in their entireties.

In some embodiments, a device/system comprises a component separation zone. The component separation zone sits in-line with the axis of centrifugal force (centrifugal force vector) of the device, such that centrifugation of the device results in force being applied to move the sample into the component separation zone (from the sample collection zone), and separating components of the sample along the length of the component separation zone, with more dense components moving further into the component separation zone (e.g., into the waste chamber 225 of FIG. 2) and less dense components moving less far into the component separation zone (e.g., into the separation chamber 220 of FIG. 2). In embodiments in which the desired components are more dense than other components of the sample, the orientation of waste and separation chambers may be reversed or otherwise altered.

The portion of the component separation zone in fluid communication with the sample metering zone may be a hole, slit, or other passage between the two zones at the desired physical location. Where components of a sample are to be separated, if a less dense component is desired to be transferred from the separation zone to the sample metering zone, the passage can be placed near the upper region of the separation zone such that a less dense, isolated component of the sample residing near the top separation zone preferentially migrates into the porous membrane of the sample metering zone via capillary force. An advantage of the device is that the porous membranes can transport sample in all directions, while the centrifugal force only transports sample radially away from the axis of rotation.

In some embodiments, a device/system comprises a metering zone. The metering zone sits orthogonal to the axis of centrifugal force of the device (orthogonal to the force vector resulting from centrifugation of the device) with respect to the component separation zone, such that application of centrifugal force to the device limits (e.g., prevents) flow of sample or sample components from the component separation zone into the metering zone; however, in the absence of centrifugal force, passive flow (e.g., capillary action) is sufficient to draw the desired separated components from the separation zone (e.g., the separation chamber 220 of FIG. 2) into the metering zone. In some embodiments, the separated components are drawn into the metering reservoir 230 via a metering channel 236 that is in fluid communication with the separation channel 220. In some embodiments, the metering pad 233, and the size and location of the metering zone relative to the component separation zone results in a desired volume of the desired component(s) advancing into the metering zone.

In some embodiments, a device/system comprises a reagent addition and mixing zone. The initial element of the reagent addition and mixing zone, the first mixing chamber, sits in-line with the axis of centrifugal force of the device (in-line with the vector resulting from centrifugation of the device) with respect to the metering reservoir (and metering pad), such that centrifugation of the device results in force being applied to move the desired component from the metering reservoir into the first mixing chamber. The first mixing chamber also sits in-line with the axis of centrifugal force of the device (in-line with the vector resulting from centrifugation of the device) with respect to the first reagent storage reservoir, such that centrifugation of the device results in force being applied to move the first reagent from the first reagent storage reservoir into the first mixing chamber. However, the first reagent is contained within the first reagent storage reservoir by the first reagent gate (in some embodiments, subsequent reagents are also contained in storage reservoirs by gates). The reagent gate prevents the reagent from exiting the reagent storage reservoir when the gate is in place and/or intact. The reagent gate prevents the reagent from entering the mixing chamber during the early centrifugation steps (e.g., before the centrifugation that results in the sample components entering the mixing chamber). Upon breaking and/or removing the first reagent gate, the first reagent is free to flow into the first mixing chamber upon the application of centrifugal force. Any suitable mechanism may find use in facilitating the release of reagents (e.g., removal of a barrier, a switch, a valve, breaking a barrier, etc.).

In some embodiments, application of centrifugal force to the device results in combination, in the first mixing chamber, of the sample components in the metering reservoir and the first regent(s) in the de-gated first reagent storage reservoir. The sample components and first reagent are substantially held in the first mixing chamber, and allowed to mix/react, as long as a threshold degree of centrifugal force is applied.

Upon the absence of a threshold degree of centrifugal force mixing/reaction products of the first mixing chamber move by passive flow into the first siphon. The shape/orientation of the first siphon aligns the mixing/reaction products of the first mixing chamber with the second mixing chamber, such that subsequent application of centrifugal force to the device will result in the mixing/reaction products of the first mixing chamber entering the second mixing chamber. As described above with the first mixing chamber, the second mixing chamber also sits in-line with the axis of centrifugal force of the device (in-line with the vector resulting from centrifugation of the device) with respect to the second reagent storage reservoir, such that centrifugation of the device results in force being applied to move the second reagent from the second reagent storage reservoir into the second mixing chamber. However, the second reagent is contained within the second reagent storage reservoir by the second reagent gate. The second reagent gate prevents the second reagent from exiting the second reagent storage reservoir when the gate is in place and/or intact. The second reagent gate prevents the second reagent from entering the mixing chamber during the early centrifugation steps (e.g., before the centrifugation that results in the mixing/reaction products of the first mixing chamber entering the second mixing chamber). Upon breaking and/or removing the second reagent gate, the second reagent is free to flow into the second mixing chamber upon the application of centrifugal force. In some embodiments, application of centrifugal force to the device results in combination, in the second mixing chamber, of the mixing/reaction products of the first mixing chamber and the second regent(s) in the de-gated second reagent storage reservoir. The mixing/reaction products of the second reaction chamber are substantially held in the second mixing chamber, and allowed to mix/react, as long as a threshold degree of centrifugal force is applied.

Reagent addition and mixing zones may comprise additional (e.g., third, fourth, fifth, sixth, etc.) siphons, reaction chambers, reagent storage reservoirs/gates/channels, oriented and comprising similar elements to those described above, depending upon the reaction requirements of the device/system/method to be employed.

Upon the absence of a threshold degree of centrifugal force mixing/reaction products of the second mixing chamber move by passive flow into the second siphon. The shape/orientation of the second siphon aligns the mixing/reaction products of the second mixing chamber with the incubation chamber, such that application of centrifugal force to the device will result in the mixing/reaction products of the second mixing chamber entering the incubation chamber. In some embodiments, the incubation chamber comprises assay reagents (e.g. antibodies) within the chamber for reaction with the mixing/reaction products of the second mixing chamber. In some embodiments, such reagents are dried to the sides of the incubation chamber. In some embodiments, as long as a threshold degree of centrifugal force is applied to the device, fluids are retained in the incubation chamber. However, once centrifugal force drops below such a threshold (e.g., when the device is not being centrifuged), the incubated fluid moves by passive flow into the assay chamber (e.g., test strip 290) as drawn by capillary action (e.g., by the absorbent pad 295). In some embodiments, the results of the assay are view/interpreted in the assay chamber.

An advantage of the systems/devices herein is the alternating passively-driven and centrifugally-driven movement of fluid through the device. Passive transport is capable of moving fluids (e.g., sample, sample components, mixing/reaction products, etc.) in all directions (x, y, z), while the centrifugation only transports fluids along the axis of centrifugal force (e.g., away from the axis of rotation). By alternating passive and centrifugal movement of fluids, discrete steps are achieved.

In some embodiments, the device further comprises air vents in fluid communication with the various chambers, zones, reservoirs, channels, etc. to facilitate the movement of fluids through the device. In some embodiments, the device further comprises various discharge channels in fluid communication with the chambers, zones, reservoirs, channels, etc. to facilitate removal of waste, sample, reaction products, etc. from the device.

The device may be manufactured as a single unit or may comprise two or more layers that are attached to one another via any suitable mechanism (e.g., adhesive, snaps, welds, etc.). In some embodiments, porous membranes are inserted into the device, and the device is sealed with addition of film or other covers. Alternatively, in some embodiments, the device comprises two or more layers and porous membrane, collection pads, gates, etc. are inserted between layers.

The size and shape of each of the zones, chambers, channels, reservoirs, and passages is selected based on, among other factors, the nature of the sample to be processed, the volume of the sample, the volume of a desired isolated component of the sample, the physical properties of the sample, the degree of purification/isolation desired, the amount of centrifugal force employed, and the capillary force of the porous membrane. The selection of material and manufacturing specification may also take these factors into account.

In some embodiments, the device is a small hand-held device. In assembled form, the device has a length (aligned with the force vector resulting from centrifugation of the device), width (orthogonal to the force vector resulting from centrifugation of the device), and depth. In some embodiments, these dimensions are selected to permit the device to fit within a collection tube and/or a centrifuge tube or bucket. In some embodiments the width is less than 30 cm (e.g., 25, 20, 15, 12, 10, 9, 8, 7, 6, 5, 4, 3, 2, 1 cm; or values or ranges therebetween). In some embodiments, the length is less than 60 cm (e.g., 55, 50, 45, 40, 35, 30, 25, 20, 15, 10, 9, 8, 7, 6, 5, 4, 3, 2, 1, 0.5, 0.25 cm; or values or ranges therebetween). In some embodiments, the depth is less than 5 cm (e.g., <5, 4, 3, 2, 1, 0.5, 0.25, 0.1 cm; or values or ranges therebetween).

In use, the devices/systems may further comprise the sample (e.g., blood), a sample component (plasma), reagents (e.g., antibodies, acid, base, etc.), mixing/reaction products, etc. The devices/systems herein find use with preparing/handling of any suitable sample. Embodiments herein are described in connection with the preparation of a blood sample for analysis, but other sample types will find use with various embodiments of the systems/devices within the scope herein. In some embodiments, a sample is any suitable biological (e.g., blood, serum, plasma, urine, cerebrospinal fluid, tears, saliva, pharyngeal epithelial cells, sputum, lymph fluids, dialysates, lavage fluids, fluids derived from organs or tissue cultures, etc.), environmental sample (e.g., water (e.g., waste water, sea water, river water, drinking water, etc.), soil, industrial samples, etc.), foodstuffs, beverages, reactants, etc. In some embodiments, a sample is a liquid or is dissolved, mixed, or emulsified into a liquid for processing on a device/system herein. In some embodiments, the systems/devices herein are configured for the handling/processing/preparation of a sample for analysis of one or more components thereof.

In some embodiments, porous membranes are coated or integrated with one or more reagents or other components that facilitate sample processing. For example, in some embodiments, the collection membrane comprises an anti-coagulant when the sample is blood. In some embodiments, the metering membrane comprises (e.g., is coated with) a stabilizing reagent or assay reagent. Such reagents include but are not limited to buffering salts, bases, acids, enzyme inhibitors, affinity reagents, detectable labels, nucleases, proteases, and the like.

Devices herein may be provided with and used in conjunction with a system. In some embodiments, a kit is provided containing the device and other components. For example, in some embodiments, systems and kits comprise a centrifuge. The centrifuge is any equipment that generates centrifugal force to the separation device—i.e., that puts an object in rotation around a fixed axis. This includes manual and electronic centrifuges. It includes fixed angle, swinging head or bucket, and continuous tubular centrifuges. In some embodiments, the system and/or kit comprises one or more collection tubes, spare porous membranes, sample collection instruments (syringes, etc.), instructions for use, data analysis instruments and/or software, reagents and/or equipment for analyzing the isolated sample component, and the like.

Further provided herein are uses of any of the devices or systems described above or elsewhere herein. Any and all uses are contemplated. In some embodiments, the use is the isolation of a component from a sample (e.g., plasma from blood).

Thus, in some embodiments, provided herein are methods of using a device or system described herein, comprising the steps of: (a) metering a sample or isolating a component of a sample, (b) adding one or more reagents to the sample or component thereof to produce a processed sample, and (c) analyzing the processed sample (e.g., performing an assay). In some embodiments, the sample, a component thereof, reagents and/or the processed sample are advanced through the device using alternative passively-driven and centrifugally-driven steps.

In some embodiments, provided herein are devices comprising a sample collection zone, a component separation zone, a metering zone, a reagent addition and mixing zone, and an analysis zone; wherein a sample, a component thereof, and reagents are advanced through the device by alternating capillary-driven and centrifugally-driven steps.

In some embodiments, provided herein are devices for collecting, processing, and analyzing a sample, comprising: (a) a sample collection zone, wherein a sample is introduced into the device (b) a sample processing zone, wherein component(s) of interest are separated from other components of the sample, a desired amount of the component(s) of interest are isolated, and one or more reagents are added to the component(s) of interest; and (c) a sample analysis zone, wherein an assay is performed and the results of said assay are observed; wherein the sample, component(s) of interest, and one or more reagents are advance through the device by alternating capillary-driven and centrifugally-driven steps. In some embodiments, the sample processing zone comprises: (i) a component separation zone, wherein component(s) of interest are separated from other components of the sample; (ii) a metering zone, wherein a desired amount of the component(s) of interest are isolated; and (iii) a reagent addition and mixing zone, wherein one or more reagents are added to the component(s) of interest. In some embodiments, the sample collection zone comprises an opening to the exterior of the device and a porous membrane for collecting the sample by capillary action. In some embodiments, the sample collection zone and the component separation zone are in fluid communication, and oriented on along the vector of centrifugal force of the device, such that application of centrifugal force to the device results in the movement of fluid from the sample collection zone to the component separation zone. In some embodiments, the component separation zone comprises a separation channel, separation chamber and a waste chamber fluid communication with each other, and oriented on along the vector of centrifugal force of the device. In some embodiments, the metering zone comprises a porous membrane, and wherein the metering zone in passive fluid communication with a portion of the separation chamber, but is not in fluid communication with the sample collection zone and/or the waste chamber. In some embodiments, the reagent addition and mixing zone comprises a mixing chamber and a reagent storage chamber, wherein the mixing chamber is oriented along the vector of centrifugal force of the device with respect to both the metering zone and the reagent storage chamber, such that application of centrifugal force to the device results in the movement of fluid from the mixing chamber and a reagent storage chamber to the mixing chamber. In some embodiments, the reagent addition and mixing zone comprises multiple sets of mixing chambers and a reagent storage chambers connected in series, such that alternating capillary-driven and centrifugally-driven steps will advance the sample into successive mixing chambers and mix the sample with successive reagents. In some embodiments, the analysis zone comprises an incubation chamber, test strip, and absorbent pad; wherein the incubation chamber is in fluid communication with the reagent addition and mixing zone, wherein the incubation chamber is oriented along the vector of centrifugal force of the device with respect to the reagent addition and mixing zone, such that application of centrifugal force to the device results in the movement of fluid from the reagent addition and mixing zone to the incubation chamber; and wherein the test strip and absorbent pad are in fluid communication with the incubation chamber such that fluid will pass from the incubation chamber to the test strip and absorbent pad by capillary flow. In some embodiments, the analysis zone further comprises antibodies.

In some embodiments, provided herein are devices comprising: a sample reservoir, a reagent reservoir, a mixing chamber, and a passive-flow channel or chamber; wherein the sample reservoir and the reagent reservoir are not in direct fluid communication with each other; wherein the mixing chamber is oriented along the vector of centrifugal force of the device with respect to the sample reservoir and the reagent reservoir, such that application of centrifugal force to the device will result in the movement of fluid from the reagent reservoir and sample reservoir to the mixing chamber; and wherein the passive-flow channel or chamber is in fluid communication with the mixing chamber, such that fluid will pass from the mixing chamber to the passive-flow channel or chamber by capillary flow, in the absence of a centrifugal force being applied to the device. In some embodiments, the sample reservoir comprises absorbent material that is configured to accept introduction of a sample by passive flow. In some embodiments, the reagent reservoir comprises a barrier that prevents flow of the reagent into the mixing chamber under centrifugation until the barrier has been removed or broken. In some embodiments, the passive-flow channel or chamber comprises a siphon. In some embodiments, the passive-flow channel or chamber comprises an absorbent material that is configured to accept fluid from the mixing chamber by passive flow in the absence of a centrifugal force being applied to the device. In some embodiments, the device further comprises a second mixing chamber, a second reagent reservoir, and a second passive-flow channel or chamber; wherein the passive-flow channel or chamber and the second reagent reservoir are not in direct fluid communication with each other; wherein the second mixing chamber is oriented along the vector of centrifugal force of the device with respect to the first passive-flow channel or chamber and the second reagent reservoir, such that application of centrifugal force to the device will result in the movement of fluid from the second reagent reservoir and first passive-flow channel or chamber to the second mixing chamber; and wherein the second passive-flow channel or chamber is in fluid communication with the second mixing chamber, such that fluid will pass from the second mixing chamber to the second passive-flow channel or chamber by capillary flow, in the absence of a centrifugal force being applied to the device. In some embodiments, a device further comprises an analysis zone, as described herein.

In some embodiments, provided herein are systems comprising a device described herein and a centrifuge.

In some embodiments, provided herein is the use of the device described herein for collecting a sample, processing the sample, and analyzing the sample. In some embodiments, the sample is blood, the sample is processed to isolate plasma from the sample, the plasma is processed to denature antibodies in the sample, and/or the processed plasma is analyzed by an immunoassay.

In some embodiments, provided herein are methods for collecting a sample, isolating a component of a sample, processing the component, and analyzing the component, using a device described herein. In some embodiments, the sample is blood, the sample is processed to isolate plasma from the sample, the plasma is processed to denature antibodies in the sample, and/or the processed plasma is analyzed by an immunoassay.

In some embodiments, provided herein are assays for the detection of a pathogen or analyte component thereof in a blood sample using the devices, systems, and methods described herein. In some embodiments, the pathogen is a virus (e.g., HIV, HCV, etc.).

### DESCRIPTION OF THE DRAWINGS

These and other features, aspects, and advantages of the present technology will become better understood with regard to the following drawings:

FIG. 1 shows a diagram of an exemplary device 100 having a sample collection zone 110, component separation zone 120, metering zone 130, reagent addition and mixing zone 140, and analysis zone 150.

FIG. 2 shows a diagram of an exemplary device 200 having a sample collection pad 210, separation channel 215, separation chamber 220, waste chamber 225, metering reservoir 230, metering pad 233, metering channel 236, first reagent storage reservoir 240, first reagent gate 242, first reagent addition channel 245, first mixing chamber 250, second mixing chamber 260, first siphon 262, first reagent storage reservoir 270, first reagent gate 272, first reagent addition channel 275, incubation chamber 280, second siphon 285, test strip 290, and absorbent pad 295.

FIG. 3 shows diagrams demonstrating the performance of an immune assay (e.g., a lateral flow hepatitis C antigen (HCV Ag) immunoassay) using an exemplary device for the collection, separation, processing, and analysis of a blood: (A) collection of blood from a finger stick into the collection pad; (B) collection device inserted into the main cartridge; (C) centrifugal force applied to the cartridge to move blood from the collection pad, through the separation channel, and into the separation chamber; (D) continued application of centrifugal force separates cells (into waste chamber) from plasma (remains in separation chamber); (E) Plasma wicked into metering pad via metering channel upon cessation of centrifugal force; (F) acid storage vial unsealed (e.g., ampule broken), and centrifugal force applied to move plasma and acid into the first mixing chamber; (G) after the acid reaction, centrifugation is stopped to allow the first siphon to prime with the acid-reacted plasma; (H) base storage vial unsealed (e.g., ampule broken), and centrifugal force applied to move acid-reacted plasma and base into the second mixing chamber; (I) after the neutralization reaction, centrifugation is stopped to allow the second siphon to prime with the neutralized plasma (e.g., rehydrating reagent); (J) centrifugation moves the processed sample from the second siphon to the incubation chamber for antibody binding; (K) centrifugation stopped to allow the antibody-bound sample to wick up test strip and antibodies to bind to test and control lines; and (L) after the antibody-bound sample is drawn into the absorbent pad, the intensities of the lines are read and analyzed.

### DEFINITIONS

To facilitate an understanding of the present technology, a number of terms and phrases are defined below. Additional definitions are set forth throughout the detailed description.

As used herein, “a” or “an” or “the” can mean one or more than one. For example, “a” widget can mean one widget or a plurality of widgets.

As used herein, the terms “subject” and “patient” refer to any animal, such as a dog, cat, bird, livestock, and particularly a mammal, preferably a human.

As used herein, the term “comprise” and linguistic variations thereof denote the presence of recited feature(s), element(s), method step(s), etc. without the exclusion of the presence of additional feature(s), element(s), method step(s), etc. Conversely, the term “consisting of” and linguistic variations thereof, denotes the presence of recited feature(s), element(s), method step(s), etc. and excludes any unrecited feature(s), element(s), method step(s), etc., except for ordinarily-associated impurities. The phrase “consisting essentially of” denotes the recited feature(s), element(s), method step(s), etc. and any additional feature(s), element(s), method step(s), etc. that do not materially affect the basic nature of the composition, system, or method. Many embodiments herein are described using open “comprising” language. Such embodiments encompass multiple closed “consisting of” and/or “consisting essentially of” embodiments, which may alternatively be claimed or described using such language.

As used herein, the term “sample” and “specimen” are used interchangeably, and in the broadest senses. In one sense, sample is meant to include a specimen or culture obtained from any source, as well as biological and environmental samples. Biological samples may be obtained from animals (including humans) and encompass fluids, solids, tissues, and gases. Biological samples include blood products, such as plasma, serum, stool, urine, and the like. Environmental samples include environmental material such as surface matter, soil, mud, sludge, biofilms, water, and industrial samples. Such examples are not however to be construed as limiting the sample types applicable to the present invention.

As used herein, the term “analyte” refers to a molecular constituent of a sample (e.g., biological sample, environmental sample, etc.) that can be detected, quantified, and/or analyzed by appropriate methods (e.g., immunoassay), for example, using the devices/systems/methods described herein. Analytes may be naturally occurring substances (e.g., obtained/provided from a biological or environmental sample) or artificial substances (e.g., synthesized).

As used herein, the term “immunoassay” refers to antibody-antigen binding assay and includes, but is not limited to, ELISA, ligand binding assay, sandwich immunoassay, indirect immunoassay, radioimmunoassay, Western Blot detection, Dot Blot assay, bead based immunoassay etc.

As used herein, the term “antibody” refers to a whole antibody molecule or a fragment thereof (e.g., fragments such as Fab, Fab′, and F(ab′)₂), unless specified otherwise. Embodiments referring to “an antibody” encompass multiple embodiments including “a whole antibody” and fragments of the antibody, which may alternatively be claimed or described using such language.

The term “system” as used herein refers to a collection of articles for use for a particular purpose. In some embodiments, the articles comprise instructions for use, as information supplied on e.g., an article, on paper, or on recordable media (e.g., diskette, CD, flash drive, etc.). In some embodiments, instructions direct a user to an online location, e.g., a website.

As used herein, the term “orthogonally” refers to a directional relationship between segments of a device, vectors, etc. that have an internal angle between them that is equal to 90°.

As used herein, the term “parallel” refers to a directional relationship between segments of a device, vectors, etc. that have a constant distance between the segments, vectors, etc. over their length (e.g., 0° angle between the segments).

As used herein, the term “antiparallel” refers to a directional relationship between segments of a device, vectors, etc. that have a constant distance between the segments, vectors, etc. over their length (e.g., 0° angle between the segments), but are oriented in opposite directions.

### DETAILED DESCRIPTION

Provided herein are devices, systems, and methods for specimen preparation by employing a combination of capillary and centrifugal forces, along with the addition of reagents at specified steps, followed by on-device sample analysis. For example, provided herein are devices, and methods of use thereof, that collect a sample by capillary force, separate components of the collected sample by centrifugal force, isolate one or more of the separated components by a second application of capillary force, mix the separated components with a first reagent from a storage compartment under centrifugal force, and continue to advance the materials through the device by alternating capillary and centrifugal forces, optionally with the addition of additional reagents from additional storage compartments, until final materials reach a test zone of the device for analysis.

To perform rapid, accurate and low-cost diagnostic tests at point of care, specimens should be collected without venipuncture and processed with minimal manual steps and equipment. The technology provided herein uses both capillary and centrifugal forces (centrifugal force is a “fictitious force” since it results from accelerating the device, not from physical interaction between two objects) in one device to collect and process specimens, achieving this goal.

The technology finds use in a wide variety of applications. For example, the devices, systems, and methods find uses where blood samples are collected from puncture sites in fingers or heels, or from primary collection vessels such as blood collection tubes, syringes or urine collection cups. For example, the devices, systems, and methods find use in any instance where a metered amount of a sample is desired and/or where a sample comprises two or more components (whether solid, liquid, or gas) and where there is a desire to at least partially isolate or purify one or more of the components. Biological samples, including but not limited to blood, blood components (e.g., plasma, serum), saliva, urine, cerebral spinal fluid, lacrimal fluid, bronchoalveolar lavage fluid, synovial fluid, nipple aspirate fluid, tear fluid, amniotic fluid, biofilms, wound components, cell culture, culture media, exosomes, proteins, nucleic acids, lipids, cell membranes or membrane components may be used. Likewise, environmental samples including but not limited to surface matter, soil, mud, sludge, biofilms, water, or industrial samples may be used. Any two components of such a sample that are separable by centrifugal force may be isolated or purified (partially or entirely) using the devices, systems, and methods. Further, any amount of a pure sample or separated sample may be metered using the devices, systems, and methods.

The devices, systems, and methods find particular use for the metering and/or separation of plasma from blood, processing of the plasma (e.g., addition of acid and base is separate steps to yield an analyzable sample), and analysis of desired components (e.g., for proteins, nucleic acid, metabolites, infectious disease components or markers, etc.) of the sampe. Such applications include, but are not limited to collecting/processing/analyzing blood at point of care or remote laboratory.

The systems, devices, and methods employ capillary and centrifugal forces to prepare/process/analyze sample. Analysis may include diagnostic, screening, or other analytical tests. Centrifugal forces are generated by spinning the device or a component of the device. In some embodiments, a device herein comprises a particular orientation for application of centrifugal force. In some embodiments, when a device is properly positioned in a centrifuge or other instrument capable of applying centrifugal force to the device, the vector of centrifugal force (away from the axis of rotation) is properly aligned with the device. Capillary forces are generated with porous media such as glass fiber membranes. Centrifugal force dominates when the device is spinning (e.g., above a threshold speed). Capillary forces dominate otherwise. By alternating centrifugal and capillary forces, sample collection, metering, separation and isolation, as well as reagent addition, mixing, and advancement of fluids through the device are facilitated. Any number of such steps may be employed, permitting complex processing/analysis of samples.

In some embodiments, suitable centrifugal forces are applied to the device/system according to the specification of the device, the type of centrifuge use, and the desired application (e.g., fractionation of blood, advancing liquids through the device, etc.). Centrifugal forces for sue with devices described herein range from 10×g to 20,000×g (e.g., 10×g, 20×g, 50×g, 100×g, 200×g, 500×g, 1,000×g, 2,000×g, 3,000, ×g, 4,000×g, 5,000×g, 10,000×g, 12,000×g, 15,000×g, 20,000×g, or ranges therebetween (e.g., 1,000-5,000×g, etc.)).

Centrifugal force moves fluids radially away from the axis of rotation (e.g., along the axis or vector of centrifugal force) out of capillary media and, as desired, separates components of heterologous samples that are amenable to separation by centrifugation (e.g., components having different densities (i.e., differing in specific gravity) such as separating cells from plasma from a blood sample). Capillary forces, when materials are positioned correctly, move fluids in directions other than in-line with the vector of centrifugal force (e.g., anti-parallel to the vector of centrifugal force, orthogonally to the vector of centrifugal force, etc.). Both forces run until equilibrium is obtained. The stable end points contribute to the precision of the device.

The devices may be configured in any way to accomplish the combination of alternating centrifugal and capillary forces. While simple devices may be preferred from a cost and ease of use standpoint, very complex devices involving a large number of alternating centrifugal and capillary forces may also be used, where desired. For example, in some embodiments, use of a device involves (cp=capillary; cf=centrifugal): cp sample collection; cf sample separation; and cp sample isolation. In other embodiments, the device involves cp sample collection; cf sample separation; cp sample isolation; and cf sample collection. In other embodiments, the devices involves cp sample collection; (cf sample separation; cp sample isolation)ₙ, where n=2 to or more (e.g., 2-5, 2-10, 2-20, 2-50, 2-100). In such embodiments, a variety of different or the same centrifugal and/or capillary forces are employed at each stage to differentially separate and isolate different components or to ensure full separation and isolation of components. For example a sample comprising components A, B, C, and D, each having different densities, may undergo a first separation/isolation combination that separates AB from CD and moves CD to a new zone. A second separation/isolation combination separates C from D and moves D to yet another new zone where it is ultimately collected and analyzed.

In some embodiments, use of a device involves: cp sample collection; cf component separation; cp component isolation, cf mixing of component and reagent, cp product isolation, cf incubation of product, and cp analysis. In other embodiments, use of a device involves: cp sample collection; cf component separation; cp component isolation, cf mixing of component and first reagent, cp first product isolation, cf mixing of first product and second reagent, cp second product isolation, cf incubation of second product, and cp analysis. Additional steps may be added, and/or the order of steps altered to produce a desired sample processing/analysis. For example, a separation step may follow a reagent addition/mixing step to isolate and/or remove a precipitate generated from a reaction.

In some embodiments, where low cost, ease of use, and durability are desired, the device has no moving parts.

In some embodiments, the portions of the device that generate capillary forces (e.g., passive flow) employ membranes having pores. In most microfluidic devices, capillary forces are generated by the walls of the channels. In embodiments of the devices herein that employ porous membranes, capillary forces are generated by surfaces in the pores of the membranes (e.g., that are inserted into one or more channels of the device). This has the advantage of generating large capillary pressures without constraining the dimensions of the channels or requiring their surfaces to be hydrophilic, greatly simplifying manufacturing. While such embodiments may often be preferred, traditional capillary channels may be employed.

Any type of porous membrane able to provide the capillary forces (passive flow) and collect a sample may be employed. Such porous membranes include materials composed of nylon, nitrocellulose, mixed cellulose esters, polysulfones, and the like. A fibrous membrane, such as, for example, glass, polyester, cotton, or spun polyethylene may be used.

There are other advantages of using porous media to generate capillary pressure (passive flow): some samples, such as blood samples containing plasma can be extracted from both the cell-depleted and cell-enriched phases since plasma flows much faster than cells in the membrane. This reduces the volume of sample required and makes the device more robust to variations in, for example, blood volume and hematocrit. Stop junctions are not required since flow stops when it reaches the end of the membrane. Reagents can be dried down in the membrane that are subsequently rehydrated and mixed with sample or sample components (e.g., plasma) as it flows in. By overcoming capillary forces with centrifugal forces, flow through the membranes can be controlled. This allows fluids to be stopped in membranes or to be completely eliminated from them.

In some embodiments, the device employs chambers that move fluids in three dimensions as opposed to two dimensions. This is accomplished, for example, by employing tiered chambers. Most microfluidic devices are 2D where fluids move only in a plane. The 3D geometry provided herein enables a tradeoff between depth and width and height of chambers, which allows the device to fit into small diameter tubes. For example, in some embodiments, it is possible to insert the device into a 5 mm diameter tube (e.g., for centrifugation). 3D fabrication also allows variable depths within a single tier. The depth of the collection chamber, which holds the collection pads, can be less than the separation chamber, which holds the sample after it is spun out of the collection pad. This allows the collection section to have a larger height-width area than the separation chamber. The larger area above makes collection more reproducible, while the smaller area below allows the bottom of the device to fit through a small orifice.

Sample collection can be by any desired mechanism. In some embodiments, a fluid sample (e.g., blood from a puncture site in a finger or heel; water from an environmental source) is directly contacted with a porous membrane in the sample collection zone. In other embodiments, a sample is collected by a collection instrument (e.g., tube (e.g., VACUTAINER blood collection tube), syringe, etc.) and then transferred to the sample collection zone. Direct contact has the advantage of not needing any additional materials or equipment for sample collection. This enables, for example, a single device to be used for collecting blood samples directly from heel or finger sticks, separating out cells, and aliquoting a specified volume of plasma.

After a component of the sample is isolated or purified by the device and collected, it may be analyzed (e.g., on-device) by any desired technique. Such techniques include, but are not limited to, immunoassays (e.g., ELISA), mass spectroscopy, electrophoresis, photometry, electrochemistry, cytometry, refractometry, densitometry, turbidimetry, PCR, affinity binding, microarray analysis, sequencing, chromatography, or the like for detection of one or more of proteins, nucleic acids, carbohydrates, lipids, metabolites, ions, toxins, small molecules, or other molecules or properties of interest. In some embodiments, a processed sample is analyzed on-device (e.g., by an immunoassay). In other embodiments, a processed sample is taken off-device for analysis.

Provided herein are exemplary designs optimized for collection of a blood sample, separation of plasma, processing the plasma for use in an immunoassay, and performing an immunoassay. This same design will find use with other sample types and types of analysis. However, it should be understood that variations on this configuration may be made to enhance performance, for different sample types, and/or for different analyses. An embodiment of the technology for collecting blood, separating plasma, processing plasma, and performing an immunoassay is described. This embodiment of the technology uses capillary and centrifugal forces to: collect a metered volume of blood; separate cells from plasma; aliquot a metered volume of plasma; mix plasma with acid to denature interfering antibodies and release targets; mix the acidified sample with base to neutralize sample so antibodies can bind; incubate sample with desired antibodies, and detect antibody binding to analytes in the sample. Capillary and centrifugal forces accomplish these functions in the following steps: capillary action draws blood into a porous membrane; centrifugal force drains blood into a chamber and separates cells; capillary action draws plasma into a porous membrane; centrifugal force mixes plasma with acid; capillary action advances acidified plasma; centrifugal force mixes acidified plasma with base; capillary action advances neutralized plasma; centrifugal force incubates neutralized plasma with antibodies; capillary action draws incubated plasma into test strip.

While the device can be constructed from any desired material and most efficiently is constructed from an injection-molded pieces with heat-sealed cover films.

### EXAMPLES

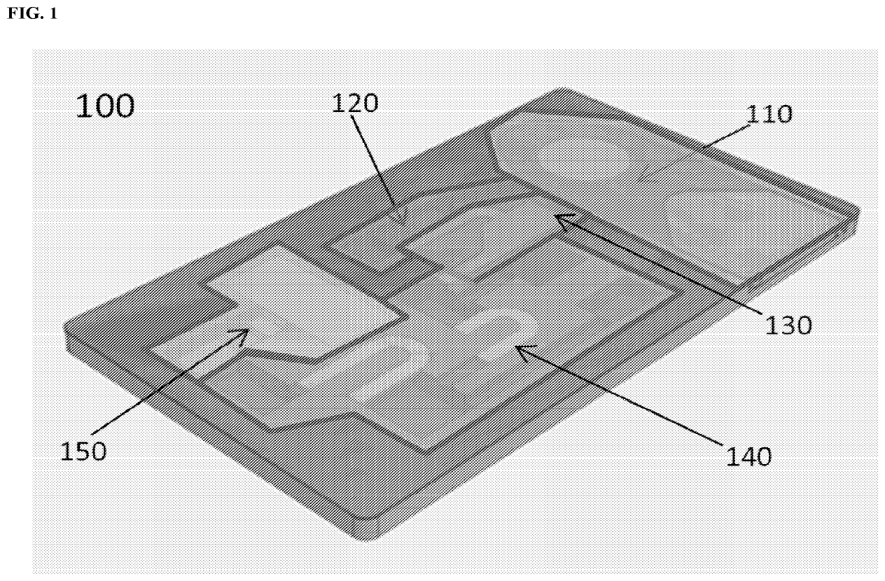

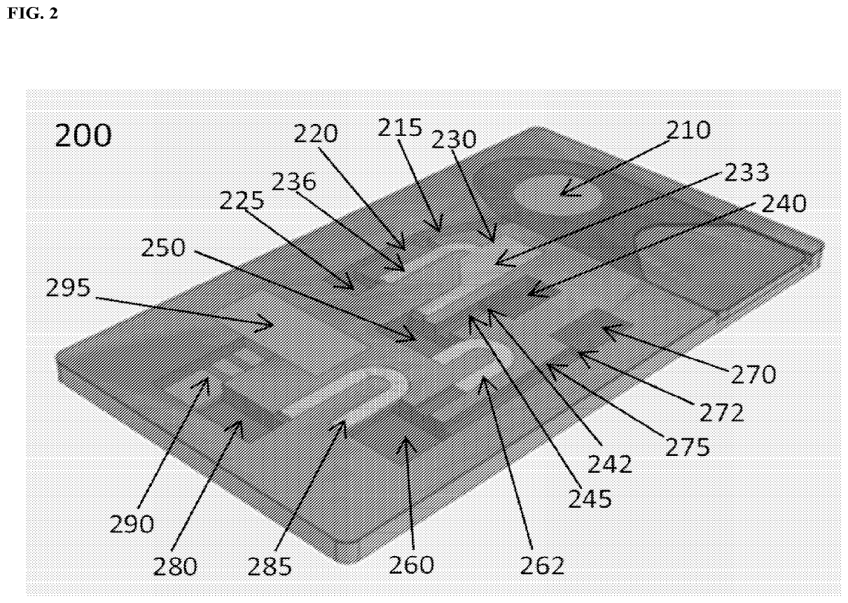

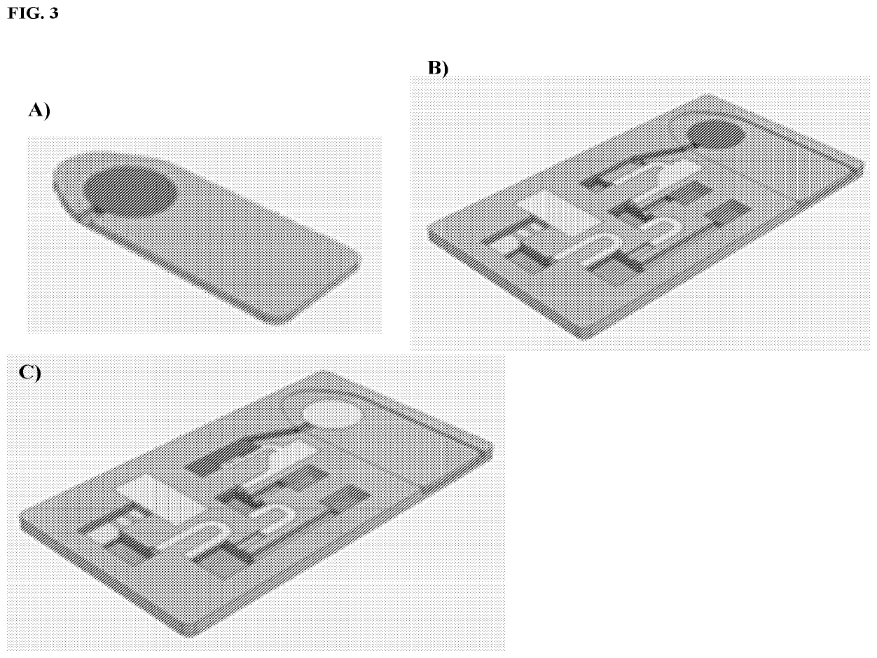

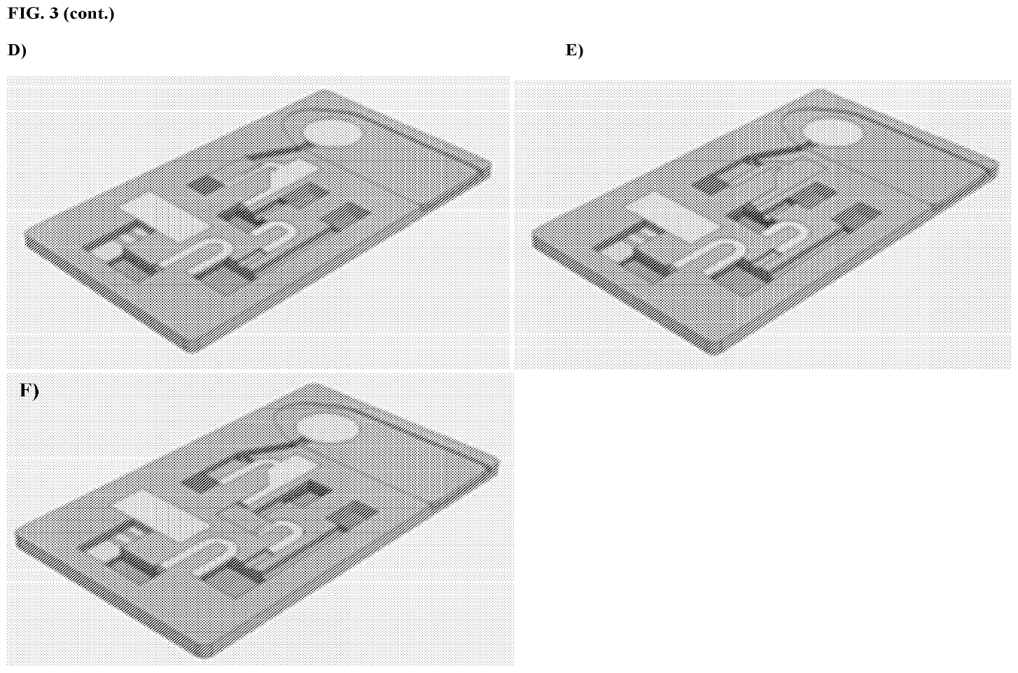

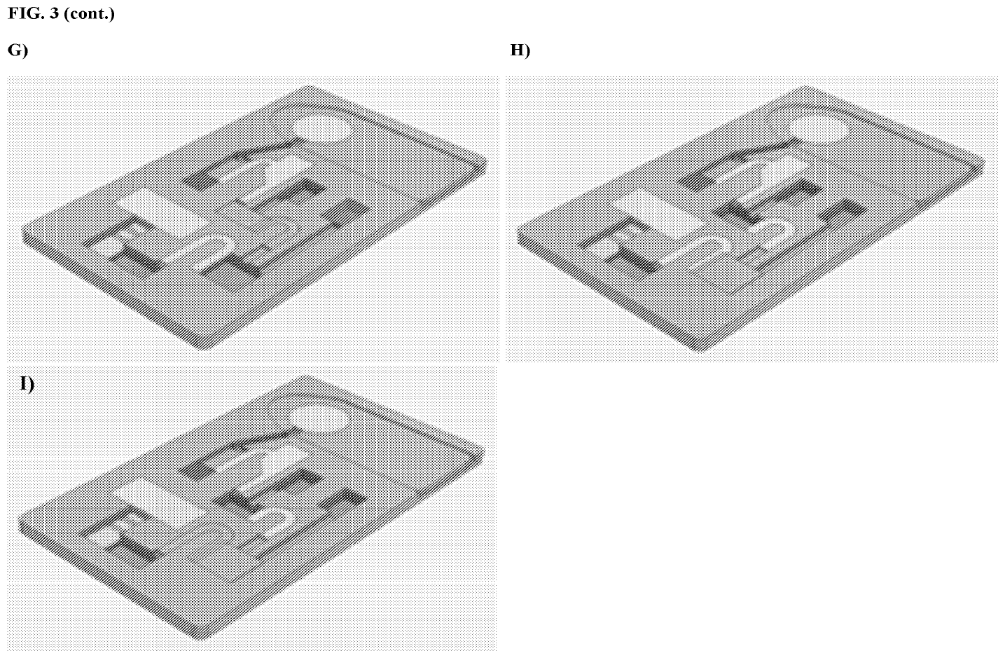

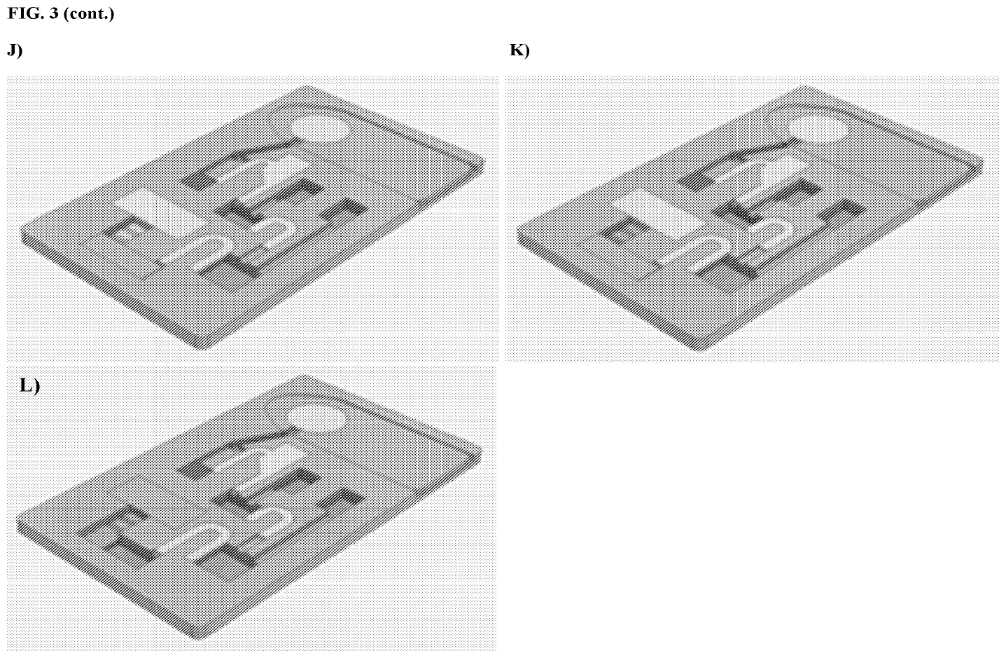

An exemplary use of the devices/systems/methods herein is to detect hepatitis C antigen (HCV Ag) in plasma by an immunoassay. The steps of such an assay are depicted in FIG. 3. An exemplary device for performing a lateral flow HCV Ag immunoassay is described herein. In such an assay, plasma is pretreated with acid to denature interfering antibodies and release targets. The acidified plasma is then neutralized with base to allow the assay antibodies to bind the analyte. The volume of plasma required (e.g., 50 μl or more) is large to achieve the required sensitivity, and after acid and base solutions are added (each equal to the plasma volume), the total volume (150 ul) that travels up the strip is very large. This requires a large volume absorbent pad beyond the test and control lines on the strip to keep the liquid flowing. A cartridge has been designed which accomplishes all of these functions (See, e.g., FIGS. 1 and 2). In this example cartridge, the specimen collection function resides on a separate device that is inserted into the side of the main cartridge to produce the sample collection zone. In this concept, all of the other components are loaded into the front side of the device and then sealed in place with a thin film. In some embodiments, the cartridge body is molded from polypropylene, which is resistant to HCl, or polycarbonate coated with thin film silica. In some embodiments, the cover is polycarbonate or polyethylene terephthalate (PET) coated with thin film silica.

In addition to the cartridge, systems and methods of utilize one or more of: a centrifuge, an actuator to break glass ampules (e.g., which contain the acid and base solutions), a heater to maintain air temperature inside the device (e.g., between 35 and 45° C., at about 40° C., etc.), a camera to image the test lines, an embedded microcontroller to step through processes and analyze images.

In some embodiments, the primary and/or secondary antibodies (e.g., biotin antibody, labelled antibody) are dried onto a chamber (e.g., incubation chamber, second mixing chamber), siphon (e.g., second siphon) or channel, or are included in a reagent mixture (e.g., base reagent, rehydration reagent, etc.).

We claim:

1. A device comprising a sample collection zone, a component separation zone, a metering zone, a reagent addition and mixing zone, and an analysis zone; wherein a sample, a component thereof, and reagents are advanced through the device by alternating capillary-driven and centrifugally-driven steps.

2. A device for collecting, processing, and analyzing a sample, comprising:
(a) a sample collection zone, wherein a sample is introduced into the device
(b) a sample processing zone, wherein component(s) of interest are separated from other components of the sample, a desired amount of the component(s) of interest are isolated, and one or more reagents are added to the component(s) of interest; and
(c) a sample analysis zone, wherein an assay is performed and the results of said assay are observed;
wherein the sample, component(s) of interest, and one or more reagents are advance through the device by alternating capillary-driven and centrifugally-driven steps.

3. The device of claim 2, wherein the sample processing zone comprises:
(i) a component separation zone, wherein component(s) of interest are separated from other components of the sample;
(ii) a metering zone, wherein a desired amount of the component(s) of interest are isolated; and
(iii) a reagent addition and mixing zone, wherein one or more reagents are added to the component(s) of interest.

4. The device of claim 2, wherein the sample collection zone comprises an opening to the exterior of the device and a porous membrane for collecting the sample by capillary action.

5. The device of claim 3, wherein the sample collection zone and the component separation zone are in fluid communication, and oriented on along the centrifugal axis of the device, such that application of centrifugal force to the device will result in the movement of fluid from the sample collection zone to the component separation zone.

6. The device of claim 3, wherein the component separation zone comprises a separation channel, separation chamber and a waste chamber fluid communication with each other, and oriented on along the centrifugal axis of the device.

7. The device of claim 3, wherein the metering zone comprises a porous membrane, and wherein the metering zone in passive fluid communication with a portion of the separation chamber, but is not in fluid communication with the sample collection zone and/or the waste chamber.

8. The device of claim 3, wherein the reagent addition and mixing zone comprises a mixing chamber and a reagent storage chamber, wherein the mixing chamber is oriented along the centrifugal axis of the device with respect to both the metering zone and the reagent storage chamber, such that application of centrifugal force to the device will result in the movement of fluid from the mixing chamber and a reagent storage chamber to the mixing chamber.

9. The device of claim 8, wherein the reagent addition and mixing zone comprises multiple sets of mixing chambers and a reagent storage chambers connected in series, such that alternating capillary-driven and centrifugally-driven steps will advance the sample into successive mixing chambers and mix the sample with successive reagents.

10. The device of claim 3, wherein the analysis zone comprises an incubation chamber, test strip, and absorbent pad;
wherein the incubation chamber is in fluid communication with the reagent addition and mixing zone, wherein the incubation chamber is oriented along the centrifugal axis of the device with respect to the reagent addition and mixing zone, such that application of centrifugal force to the device will result in the movement of fluid from the reagent addition and mixing zone to the incubation chamber;
wherein the test strip and absorbent pad are in fluid communication with the incubation chamber such that fluid will pass from the incubation chamber to the test strip and absorbent pad by capillary flow.

11. The device of claim 10, wherein the analysis zone further comprises antibodies.

12. A device comprising: a sample reservoir, a reagent reservoir, a mixing chamber, and a passive-flow channel or chamber;
wherein the sample reservoir and the reagent reservoir are not in direct fluid communication with each other;
wherein the mixing chamber is oriented along the centrifugal axis of the device with respect to the sample reservoir and the reagent reservoir, such that application of centrifugal force to the device will result in the movement of fluid from the reagent reservoir and sample reservoir to the mixing chamber;
and wherein the passive-flow channel or chamber is in fluid communication with the mixing chamber, such that fluid will pass from the mixing chamber to the passive-flow channel or chamber by capillary flow, in the absence of a centrifugal force being applied to the device.

13. The device of claim 12, wherein the sample reservoir comprises absorbent material that is configured to accept introduction of a sample by passive flow.

14. The device of claim 12, wherein the reagent reservoir comprises a barrier that prevents flow of the reagent into the mixing chamber under centrifugation until the barrier has been removed or broken.

15. The device of claim 12, wherein the passive-flow channel or chamber comprises a siphon.

16. The device of claim 12, wherein the passive-flow channel or chamber comprises an absorbent material that is configured to accept fluid from the mixing chamber by passive flow in the absence of a centrifugal force being applied to the device.

17. The device of claim 12, further comprising a second mixing chamber, a second reagent reservoir, and a second passive-flow channel or chamber;
wherein the passive-flow channel or chamber and the second reagent reservoir are not in direct fluid communication with each other;
wherein the second mixing chamber is oriented along the centrifugal axis of the device with respect to the first passive-flow channel or chamber and the second reagent reservoir, such that application of centrifugal force to the device will result in the movement of fluid from the second reagent reservoir and first passive-flow channel or chamber to the second mixing chamber;
and wherein the second passive-flow channel or chamber is in fluid communication with the second mixing chamber, such that fluid will pass from the second mixing chamber to the second passive-flow channel or chamber by capillary flow, in the absence of a centrifugal force being applied to the device.

18. The device of one of claims 12-17, further comprising an analysis zone.

19. A device comprising a plurality of chambers, each chamber configured to contain a volume of a liquid sample;
wherein the device is configured for centrifugation, and wherein upon centrifugation of the device a centrifugal force vector is applied along one dimension of the device;
wherein a first chamber and second chamber are in fluid commination and oriented along the centrifugal force vector such that upon centrifugation of the device, all or a portion of a liquid sample in the first chamber migrates to the second chamber;
wherein a third chamber contains a porous material, is in fluid communication with the second chamber, and is oriented off the centrifugal force vector with respect to the second chamber such that upon centrifugation of the device a liquid sample in the second chamber remains in the second chamber, but in the absence of centrifugal force all or a portion of a liquid sample in the second chamber migrates to the third chamber via capillary force;
wherein a fourth chamber is in fluid commination with the third chamber, and is oriented along the centrifugal force vector with respect to the third chamber such that upon centrifugation of the device, all or a portion of a liquid sample in the third chamber migrates to the fourth chamber.

20. The device of claim 19, further comprising a first reservoir, wherein the first reservoir is in fluid commination with the second chamber or fourth chamber and is oriented along the centrifugal force vector with respect to the second or fourth chamber such that upon centrifugation of the device, all or a portion of a liquid sample in the first reservoir migrates to the second or fourth chamber.

21. A system comprising a device of any of claims 1-20 and a centrifuge.

22. Use of the device of any of claims 1-20 for collecting a sample, processing the sample, and analyzing the sample.

23. The use of claim 22, wherein the sample is blood, the sample is processed to isolate plasma from the sample, the plasma is processed to denature antibodies in the sample, and/or the processed plasma is analyzed by an immunoassay.

24. A method for collecting a sample, isolating a component of a sample, processing the component, and analyzing the component, using a device of any of claims 1-20.

25. The method of claim 24, wherein the sample is blood, the sample is processed to isolate plasma from the sample, the plasma is processed to denature antibodies in the sample, and/or the processed plasma is analyzed by an immunoassay.

26. An assay for the detection of a pathogen in a blood sample, comprising the method of claim 25.

27. The assay of claim 26, wherein the pathogen is HCV or HIV.
